(19) United States
(12) Patent Application Publication
(10) Pub. No.: US 2023/0071319 A1
(43) Pub. Date: Mar. 9, 2023

(54) INFORMATION PROCESSING APPARATUS, INFORMATION PROCESSING METHOD AND NON-TRANSITORY STORAGE MEDIUM

(71) Applicant: TOYOTA JIDOSHA KABUSHIKI KAISHA, Toyota-shi (JP)

(72) Inventors: Yukinori II, Toyota-shi (JP); Kenji YAMAGUCHI, Miyoshi-shi (JP); Junya OGAWA, Okazaki-shi (JP); Yuki NAGANUMA, Nagoya-shi (JP); Junya YAMAMOTO, Seto-shi (JP); Yuta TONE, Nagoya-shi (JP); Naoki ISHIZUKA, Nagoya-shi (JP); Tadayuki TANAKA, Nagoya-shi (JP); Keisuke ITO, Okazaki-shi (JP); Yuka YOKOI, Miyoshi-shi (JP); Takashi HAYASHI, Nagoya-shi (JP); Naoya OKA, Nagakute-shi (JP); Yu HAMADA, Nagoya-shi (JP)

(73) Assignee: TOYOTA JIDOSHA KABUSHIKI KAISHA, Toyota-shi (JP)

(21) Appl. No.: 17/882,168

(22) Filed: Aug. 5, 2022

(30) Foreign Application Priority Data
Sep. 6, 2021 (JP) 2021-144725

(51) Int. Cl. B05D 7/14; C09D 4/00

(52) U.S. Cl. CPC B05D 7/144; C09D 4/00

(57) ABSTRACT

The present disclosure provides information about a coating history of a vehicle. An information processing apparatus executes acquiring, for a vehicle with a later peelable second coating film formed being layered on at least a part of a first coating film, history data that is data about work on the second coating film, and acquiring a first image that is an external appearance image of the vehicle before the second coating film being formed, based on the history data.

### CROSS REFERENCE TO THE RELATED APPLICATION

This application claims the benefit of Japanese Patent Application No. 2021-144725, filed on Sep. 6, 2021, which is hereby incorporated by reference herein in its entirety.

### BACKGROUND

### Technical Field

The present disclosure relates to an information processing apparatus that provides data about a vehicle.

### Description of the Related Art

There is a request to change the body color of an automobile according to taste. In this regard, for example, Japanese Patent Laid-Open No. 2008-287192 discloses an apparatus capable of causing the body color of an automobile to change according to an external environment.

[Patent document 1] Japanese Patent Laid-Open No. 2008-287192.

### SUMMARY

One or more aspects of the present disclosure are directed to provide information about a coating history of a vehicle.

A first aspect of the present disclosure may be an information processing apparatus comprising a controller comprising at least one processor, the controller being configured to execute acquiring, for a vehicle with a later peelable second coating film formed being layered on at least a part of a first coating film, history data that is data about work on the second coating film, and acquiring a first image that is an external appearance image of the vehicle before the second coating film being formed, based on the history data.

Further, a second aspect of the present disclosure may be an information processing method comprising providing information about a vehicle with a later peelable second coating film formed being layered on at least a part of a first coating film, wherein a first image that is an external appearance image of the vehicle before the second coating film being formed is acquired based on history data that is data about work on the second coating film for the vehicle.

Further, another aspect of the present disclosure may be a computer-readable storage medium non-transitorily storing a program for causing a computer to execute the information processing method described above.

According to the present disclosure, it is possible to provide information about a coating history of a vehicle.

### BRIEF DESCRIPTION OF THE DRAWINGS

FIG. 1 is a diagram illustrating an outline of a vehicle management system;

FIG. 2 is a diagram illustrating configurations of a management server, a base server and a user apparatus;

FIG. 3 illustrates an example of a screen to present detailed information about a vehicle;

FIG. 4A illustrates an example of data stored in a coating database;

FIG. 4B illustrates an example of data stored in a sales database;

FIG. 5A illustrates an example of operation data generated by the base server;

FIG. 5B illustrates an example of operation data generated by the base server;

FIG. 6A illustrates a schematic diagram of coating by easy-to-peel paint;

FIG. 6B illustrates a schematic diagram of coating by easy-to-peel paint;

FIG. 7 is a flowchart of a process executed by the base server;

FIG. 8 illustrates an example of a screen provided by the base server;

FIG. 9A illustrates an example of a screen provided by the base server;

FIG. 9B illustrates an example of a screen provided by the base server;

FIG. 10 is a flowchart of a process executed by the management server;

FIG. 11 is a sequence diagram of a process for acquiring vehicle information;

FIG. 12 is a flowchart of a process executed at step S33;

FIG. 13 illustrates an example of a screen to present information about body colors; and

FIG. 14 is a flowchart of a process executed at step S34 in a third embodiment.

### DESCRIPTION OF THE EMBODIMENTS

There is a technology of applying coating to the body of a vehicle using a peelable coating film. Since such a coating film can be peeled later, it is possible to change the body color at an arbitrary timing. Thereby, it becomes possible to select a body color that is popular in the used automobile market at the time of purchasing a vehicle, overpaint the vehicle with the purchaser's favorite color to use the vehicle and return the color to the original color at the time of selling the vehicle. Further, since an original coating film is protected by the overpainted coating, the value of a used automobile can be enhanced in comparison with the case of not applying overpainted coating.

Note that, in this specification, “overpainting” refers to forming a peelable second coating film on a first coating film that a vehicle includes. The second coating film may be a coating film with one or more layers that can be peeled later. Further, “peeling (of coating)” refers to removing the second coating film. Further, “overpainted coating” refers to peelable coating that is layered on an existing coating film using a coating film that includes an easy-to-peel layer.

Note that, in this specification, a coating film may be used as a term that refers to a film of paint applied in a process of coating, a peelable film or a combination thereof.

In a sales advertisement of a used automobile, an image obtained by photographing the external appearance of the vehicle may be generally used. However, when a vehicle to which overpainted coating is applied is sold, it may be difficult to illustrate what color the original coating is. For example, when a vehicle to which overpainted coating is applied is sold, it is possible to present the current external appearance of the vehicle, but it is not possible to present the external appearance after the overpainted coating being peeled, at that time.

An information processing apparatus according to the present disclosure may solve such a problem.

An information processing apparatus according to a first aspect of the present disclosure may include a controller comprising at least one processor, the controller being configured to execute acquiring, for a vehicle with a later peelable second coating film formed being layered on at least a part of a first coating film, history data that is data about work on the second coating film, and acquiring a first image that is an external appearance image of the vehicle before the second coating film being formed, based on the history data.

The second coating film may be a coating film that can be peeled later. The second coating film may be, for example, a combination of a peelable film and a normal coating film or may be a colored coating film that is peelable itself (a coating film of easy-to-peel paint). By forming a peelable coating film on a coating film that a vehicle originally includes, it becomes possible to easily change the body color.

The history data may be data about work on the second coating film. The work on the second coating film is any of operation of forming the second coating film on the vehicle body or operation of peeling the second coating film. The external appearance image may be an image illustrating the external appearance of the vehicle. The external appearance image may be obtained by photographing the vehicle or may be generated by image processing.

The history data may include the external appearance image of the vehicle before the second coating film being formed or may include an external appearance image of the vehicle after the second coating film being formed, for example. Further, the history data may include information about the color of the first coating film or may include information about the color of the second coating film.

The information processing apparatus according to embodiments can acquire or generate the first image illustrating the external appearance of the vehicle before the second coating film being formed, by using such data.

Specific embodiments of the present disclosure will be described below based on drawings. Hardware configuration, module configuration, functional configuration and the like described in each embodiment are not intended to limit the technological scope of the disclosure only to the components unless otherwise stated.

### First Embodiment

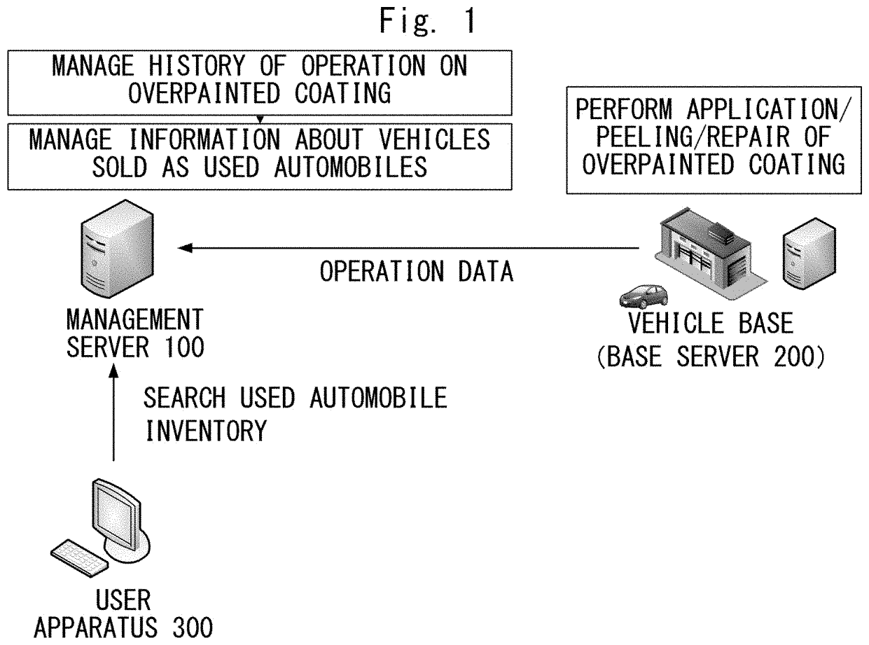

An outline of a vehicle management system according to a first embodiment will be described with reference to FIG. 1.

The vehicle management system according to the present embodiment is configured including a management server 100 that manages information about a plurality of vehicles, a base server 200 corresponding to a vehicle base and a user apparatus 300.

The management server 100 is an apparatus that manages information about vehicles manufactured by manufacturers and provided for users. For the management target vehicles, coating operation can be performed at a predetermined vehicle base. The coating operation includes, for example, (1) operation of forming a first coating film (an original coating film) at the time of manufacturing a new automobile, (2) operation of forming a second coating film (a peelable coating film) on the first coating film, (3) operation of peeling the second coating film from the vehicle, and the like. By forming a second coating film on a first coating film at a vehicle base, the body color of a vehicle can be changed. Further, by peeling the second coating film, the body color of the vehicle can be returned to the original color.

The management server 100 includes a database for recording histories of coating operation performed in the past (hereinafter, coating histories) for the plurality of vehicles under its management.

Furthermore, the management server 100 includes a database for recording information about vehicles to be sold to users (for example, profile of the vehicles and the like). Thereby, the management server 100 can provide a used automobile inventory search function.

The base server 200 is a server apparatus associated with a vehicle base where coating operation is performed for a vehicle. The vehicle base is, for example, a vehicle manufacturing factory, a maintenance shop, a car dealer or the like. When coating operation is performed for a predetermined vehicle, the base server 200 generates data indicating details of the coating operation (hereinafter, operation data) and transmits the operation data to the management server 100. Thereby, the database is updated.

A user apparatus 300 is a computer owned by a user who purchases a vehicle. When the user apparatus 300 transmits a request to search used automobile inventory information to the management server 100, the management server 100 acquires information from the database in response to the request, acquires information about used automobiles for sale and provides the information. The user apparatus 300 may be a computer installed at a business operator's shop (for example, a used automobile dealer or the like).

Though a form of selling used automobiles is exemplified in this example, vehicles to be sold may be new automobiles or pre-registered automobiles.

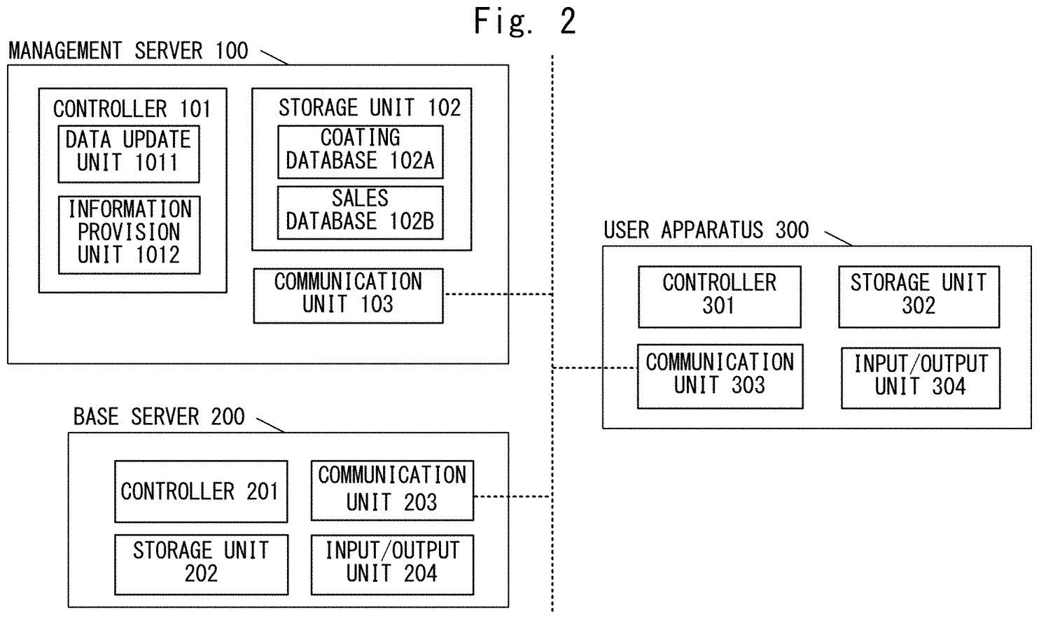

FIG. 2 is a diagram illustrating components of the management server 100, the base server 200 and the user apparatus 300 that are included in the vehicle management system according to the present embodiment in more detail. Here, the user apparatus 300 will be described first.

The user apparatus 300 is configured including a controller 301, a storage unit 302, a communication unit 303 and an input/output unit 304.

The controller 301 is an arithmetic device in charge of control performed by the user apparatus 300. The controller 301 can be realized by an arithmetic processing device such as a CPU (central processing unit).

The controller 301 executes a function of accessing the management server 100 to perform interaction. This function may be realized by a web browser or dedicated application software running on the user apparatus 300.

The storage unit 302 is configured including a main memory and an auxiliary storage device. The main memory is a memory where programs executed by the controller 301 and data used by the control programs are developed. The auxiliary storage device is a device in which the programs executed by the controller 301 and the data used by the control programs are stored. In the auxiliary storage device, an application obtained by packaging the programs executed by the controller 301 may be stored. Further, an operating system for executing the applications may be stored. By a program stored in the auxiliary storage device being loaded onto the main memory and executed by the controller 301, processes described below are performed.

The communication unit 303 is a wireless communication interface for connecting the user apparatus 300 to a network. The communication unit 303 is configured to be communicable with the management server 100 via a wireless LAN or a mobile communication service such as 3G, LTE or 5G.

The input/output unit 304 is a unit that accepts an input operation performed by a user and presents information to the user. The input/output unit 304 is configured, for example, with one touch panel display. The input/output unit 304 may be configured with a liquid crystal display and a control means therefor, or a touch panel and a control means therefor.

Next, the management server 100 will be described.

The management server 100 manages the database that stores coating histories for the plurality of vehicles under its management (hereinafter, a coating database). Further, the management server 100 updates the coating database based on operation data received from the base server 200.

Furthermore, the management server 100 manages the database that stores information about vehicles for sale (hereinafter, a sales database).

In response to an inquiry from a user apparatus 300, the management server 100 acquires detailed information about a predetermined vehicle from these databases and provides the information.

The management server 100 can be configured with a computer. That is, the management server 100 can be configured as a computer that includes a processor such as a CPU or a GPU, a main memory such as a RAM and a ROM, an auxiliary storage device such as an EPROM, a hard disk drive or a removable medium. In the auxiliary storage device, an operating system (OS), various kinds programs, various kinds of tables and the like are stored. By loading a program stored in the auxiliary storage device onto a work area of the main memory to execute the program, and each of the components and the like being controlled through the execution of the program, each function corresponding to a predetermined purpose as described later can be realized. However, a part or all of the functions may be realized by a hardware circuit such as an ASIC or an FPGA.

The management server 100 is configured including a controller 101, a storage unit 102 and a communication unit 103.

The controller 101 is an arithmetic device in charge of control performed by the management server 100. The controller 101 can be realized by an arithmetic processing device such as a CPU.

The controller 101 is configured including two functional modules of a data update unit 1011 and an information provision unit 1012. Each functional module may be realized by executing a stored program by the CPU.

The data update unit 1011 updates the database that stores coating histories of vehicles (the coating database) based on data received from the base server 200. When receiving operation data from a base server 200 (that is, when coating operation has been performed for a given vehicle), the data update unit 1011 adds a record corresponding to the content of the operation data to the coating database.

When a vehicle is newly manufactured, the vehicle includes an original body color. When coating operation is performed for the vehicle, overpainting of coating is performed, and the body color changes. Further, when the overpainted coating is peeled, the body color also changes.

Since the coating database holds all histories of the coating operation from the time of manufacturing a new automobile, a third person can obtain information about what condition the coating of a given vehicle is in, by referring to the coating database. Furthermore, the coating database stores external appearance images of the vehicle before and after the coating operation. Thereby, it is possible to provide an original image of a given vehicle. Details of the coating database will be described later.

The information provision unit 1012 generates and outputs information about a vehicle based on the database that manages information about vehicles for sale (the sales database) stored in the storage unit 102 described later. The sales database stores information about conditions of the vehicle, images of the vehicles, specifications of the vehicles, profiles of the vehicles, information about sales prices and the like, and the information provision unit 1012 generates a screen to be provided for a user (that is, a vehicle purchaser) based on the pieces of information. The information provision unit 1012 may provide the pieces of information to the user via a web server.

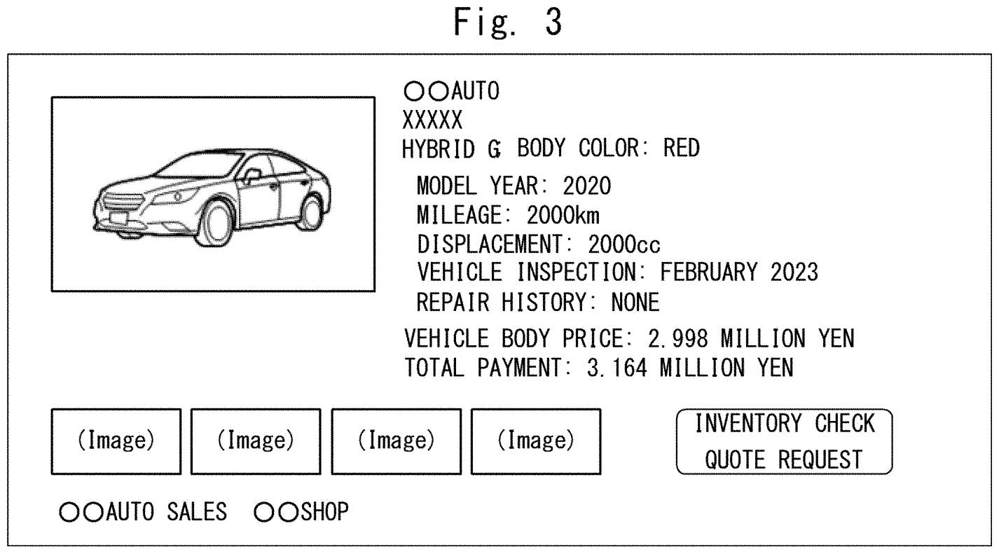

FIG. 3 illustrates an example of a screen generated by the information provision unit 1012.

When peelable coating is overpainted on a vehicle for sale, there may be a case where information about the original coating cannot be provided only by information stored in the sales database. Therefore, the information provision unit 1012 acquires the original external appearance image of the target vehicle based on information stored in the coating database described above. Thereby, the body color after the coating being peeled can be presented to the user. A specific process will be described later.

The storage unit 102 is configured including a main memory and an auxiliary storage device. The main memory is a memory where programs executed by the controller 101 and data used by the control programs are developed. The auxiliary storage device is a device in which the programs executed by the controller 101 and the data used by the control programs are stored.

Further, the storage unit 102 stores a coating database 102A and a sales database 102B.

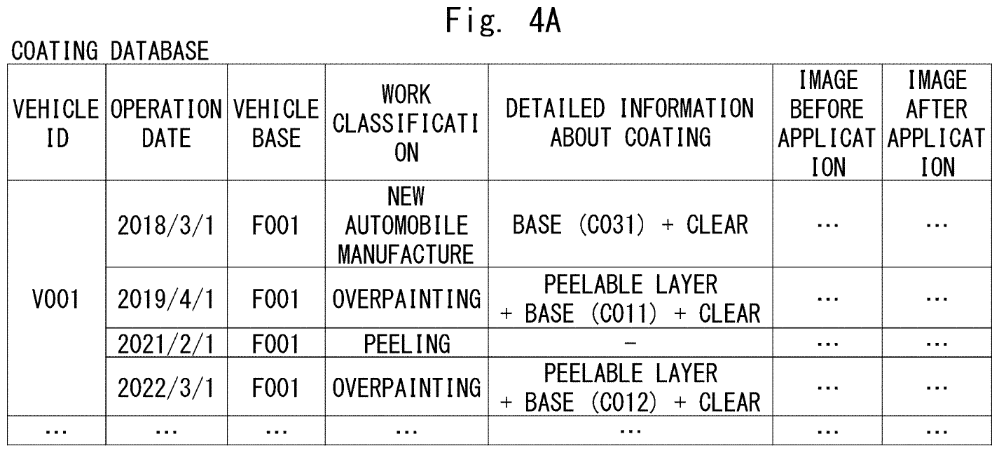

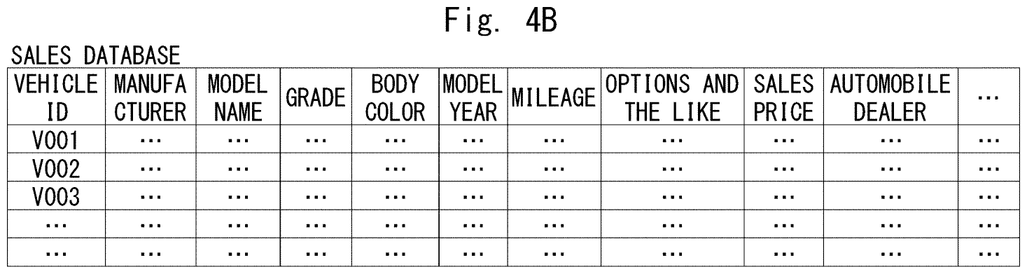

The coating database 102A is a database that stores histories of coating operation performed for particular vehicles. FIG. 4A illustrates an example of data stored in the coating database 102A.

In the present embodiment, coating operation is any of (1) coating operation at the time of manufacturing a new automobile, (2) operation of forming a peelable coating film (overpainting) and (3) operation of peeling the coating film. In the example of FIG. 4A, one record corresponds to one time of coating operation. When operation data is received from a base server 200 (that is, coating operation has been performed for a certain vehicle), a record corresponding to the coating operation is newly added.

The coating database 102A includes, for each vehicle, an identifier, the dates when coating operation was performed, vehicle bases where coating operation was performed, work classifications (coating operation classification; that is, any of (1) to (3) described above), detailed information about coating and the like. The detailed information about coating is, for example, information indicating what coating was applied for which layer. The detailed information about coating includes application order of coating films, color numbers of the coating films (in the illustrated example, C011, C012 and the like) and the like. Of course, other information may be included.

Furthermore, the coating database 102A stores external appearance images before coating operation being performed (images before application) and external appearance images after coating operation being performed (images after application). These images are photographed by staff members at vehicle bases.

The sales database 102B is a database that stores information about vehicles for sale (an inventory database). FIG. 4B illustrates an example of data stored in the sales database 102B. The sales database 102B stores, for each vehicle, a manufacturer, a model name, a grade, an original body color, a model year, mileage, options, whether an inspection has been performed or not, whether there is a repair history or not, a sales price, information about an automobile dealer and the like.

The sales database 102B is maintained by an automobile dealer owning the target vehicle as inventory. The sales database 102B may be shared by a plurality of automobile dealers through a network.

Each piece of data described above may be constructed by a database management system (DBMS) program, which is executed by the processor, managing data stored in the storage device. In this case, each piece of data may be, for example, a relational database.

The communication unit 103 is a communication interface for connecting the management server 100 to a network. The communication unit 103 is configured, for example, including a network interface board and a wireless communication interface for wireless communication.

Next, the base server 200 will be described.

The base server 200 is a computer installed at a base where coating operation for a vehicle is performed and, when coating operation is performed for a vehicle, transmits data about the content of the coating operation (operation data) to the management server 100.

The coating operation is performed, for example, when there is an order for coating by a user. Further, when a target vehicle is a leased vehicle, there may be a case where coating is peeled to return the body color to an original body color at the time of returning the vehicle. Furthermore, there may be a case where coating of a vehicle purchased as a used automobile is peeled in response to a business operator's instruction. Note that a base server 200 may be installed at a base where vehicles are manufactured (a manufacturing base).

Similarly to the management server 100, the base server 200 can be configured with a computer. That is, the base server 200 can be configured as a computer that includes a processor such as a CPU or a GPU, a main memory such as a RAM and a ROM, an auxiliary storage device such as an EPROM, a hard disk drive or a removable medium.

The base server 200 is configured including a controller 201, a storage unit 202, a communication unit 203 and an input/output unit 204.

The controller 201 is an arithmetic device in charge of control performed by the base server 200. The controller 201 can be realized by an arithmetic processing device such as a CPU.

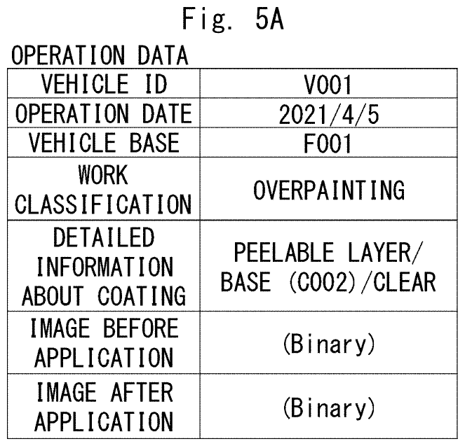

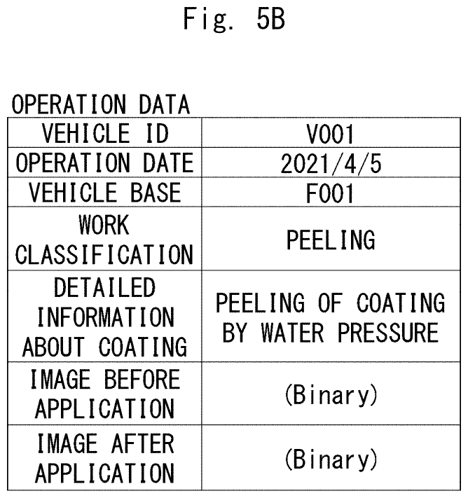

The controller 201 generates operation data based on the content of an input made by a staff member at the vehicle base and transmits the operation data to the management server 100. FIGS. 5A and 5B illustrate diagrams exemplifying the content of the operation data.

As illustrated, the operation data includes fields for a vehicle identifier, an operation date, a vehicle base, a work classification, detailed information about coating, an image before application and an image after application.

The vehicle identifier is an identifier that uniquely identifies a target vehicle (for example, a chassis number, a VIN (vehicle identification number) or the like). The operation date is a date when the operation was performed, and the “vehicle base” indicates an identifier that uniquely identifies a vehicle base where the coating operation was performed. For the work classification, any of “coating at the time of manufacturing a new automobile”, “overpainting (of coating)” and “peeling (of overpainted coating)” is stored.

The “detailed information about coating” is a field where information about details of coating is stored.

Specifically, characteristics of paint (whether peelable or not), information about color (a color number or the like), whether layered coating is applied or not, order of layered coatings, whether there is an additional layer (such as a clear layer) and the like are stored.

The image before application is an external appearance image of the vehicle photographed before coating operation being performed. The image after application is an external appearance image of the vehicle photographed after the coating operation being performed.

FIGS. 5A and 5B illustrate examples of operation data generated when overpainting of coating and peeling of overpainted coating are performed, respectively.

Note that, when the base server 200 is an apparatus corresponding to a manufacturing base of a vehicle, the base server 200 may generate operation data to the effect that coating is performed when newly manufacturing the vehicle. In this case, the work classification is “coating at the time of manufacturing a new automobile”.

The operation data is generated by the controller 201 based on information inputted via the input/output unit 204 described later and transmitted to the management server 100.

The storage unit 202 is configured including a main memory and an auxiliary storage device. The main memory is a memory where programs executed by the controller 201 and data used by the control programs are developed. The auxiliary storage device is a device in which the programs executed by the controller 201 and the data used by the control programs (including operation data) are stored.

The communication unit 203 is a communication interface for connecting the base server 200 to a network. The communication unit 203 is configured, for example, including a network interface board and a wireless communication interface for wireless communication.

The input/output unit 204 is a unit that accepts an input operation performed by a user and presents information to the user. The input/output unit 204 may include, for example, an interface with an external display, a keyboard, a mouse and the like.

Note that the configuration illustrated in FIG. 2 is an example, and all or a part of the illustrated functions may be executed using a circuit designed for dedicated use. Further, storage or execution of a program may be performed by a combination of a main memory and an auxiliary storage device other than those that are illustrated.

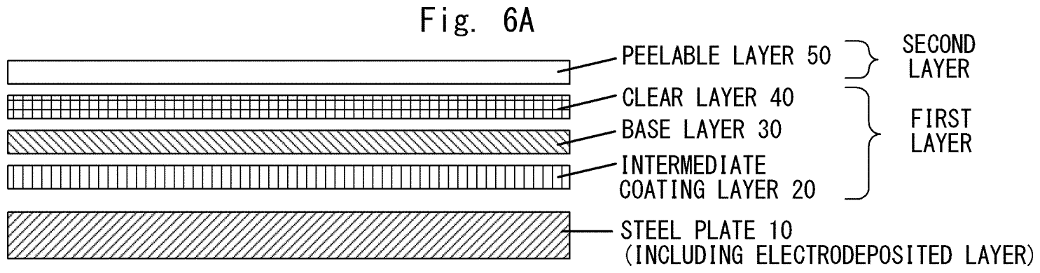

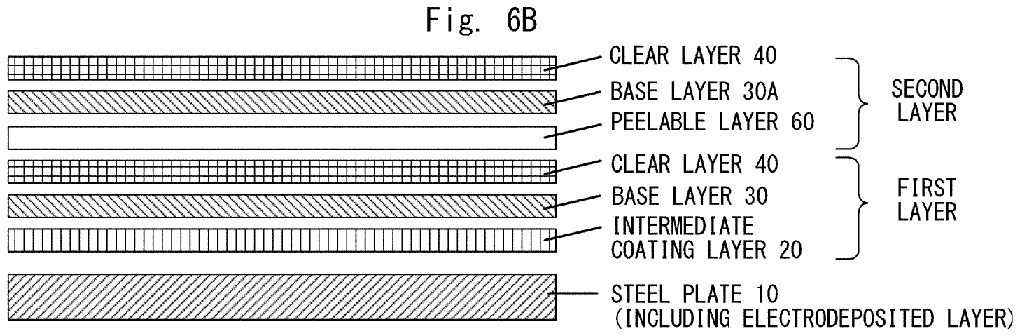

Here, a peelable coating film will be simply described. FIG. 6A is a schematic sectional view illustrating a body member (for example, a steel plate) that a vehicle body includes and coating films applied on the body member. As illustrated, the body member includes a steel plate 10 which is metal worked and on which an electrodeposited layer is formed, and an intermediate coating layer 20, a base layer 30 and a clear layer 40 that are formed sequentially on the electrodeposited layer.

These layers correspond to coating in the first layer (original coating).

A peelable layer 50 is formed on the outer surface of the body member as the second layer. The peelable layer 50 is a layer of easy-to-peel paint, which includes a property of being easily peeled by force being applied in comparison with a normal coating film. The peelable layer 50 is formed by applying easy-to-peel paint to the body member, for example, by a spraying method. As the easy-to-peel paint, paint made of xylene, ethylbenzene, an antioxidant, methyl ethyl ketone, silica reactant, titanium oxide (nanoparticles), an organic solvent and the others is exemplified.

Overpainted coating of a vehicle with easy-to-peel paint can be performed at a predetermined vehicle base. Thereby, it is possible to easily change the body color of a vehicle (that is, change the body color from a first body color to a second body color). The same goes for peeling of the peelable layer 50. By peeling the peelable layer 50 at a predetermined vehicle base, the body color of a vehicle can be returned to an original color (that is, returned from the second body color to the first body color).

Note that, though a steel plate is exemplified as the body member in this example, the body member may be a resin member. In this case, the intermediate coating layer 20 is a primer layer. A clear layer may be further provided on the peelable layer 50.

Note that, though the easy-to-peel property is given to the paint itself in the example of FIG. 6A, normal coating may be applied on a layer including the easy-to-peel property. For example, as illustrated in FIG. 6B, a peelable layer 60 that is not colored may be formed with material similar to that of the peelable layer 50, and a base layer 30A and a clear layer 40A may be formed on the peelable layer 60. The base layer 30A is a paint layer including a color different from the base layer 30. In such a form, it is also possible to remove the paint layers by peeling the peelable layer 60.

Note that, though single color is exemplified as each of a body color and a color of overpainted coating in this example, coating with a plurality of colors may be applied. For example, a plurality of colors arranged in a predetermined pattern may be a body color. Further, “color” in this specification may be such that is expressed not only by a single layer but by a plurality of layers of paint or material. The plurality of layers may include, for example, a clear layer, a glass flake layer, a mica layer, a pearl layer and the like.

Further, overpainted coating may be applied at least to a part of original coating. That is, overpainted coating does not have to cover all the original coating. For example, when an original body color is black, it is possible to, by overpainting blue on a part of the body, obtain a vehicle including two-tone color of black and blue.

Next, details of a process executed by apparatuses included in the vehicle management system will be described.

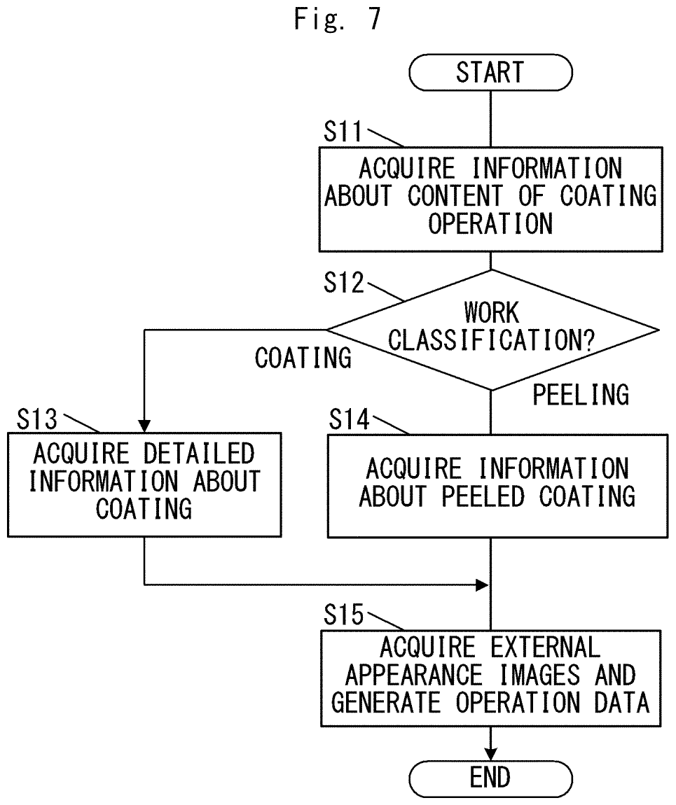

FIG. 7 is a flowchart illustrating a process executed by the base server 200 (the controller 201). The process illustrated in FIG. 7 is executed when coating is applied to a vehicle at a predetermined vehicle base.

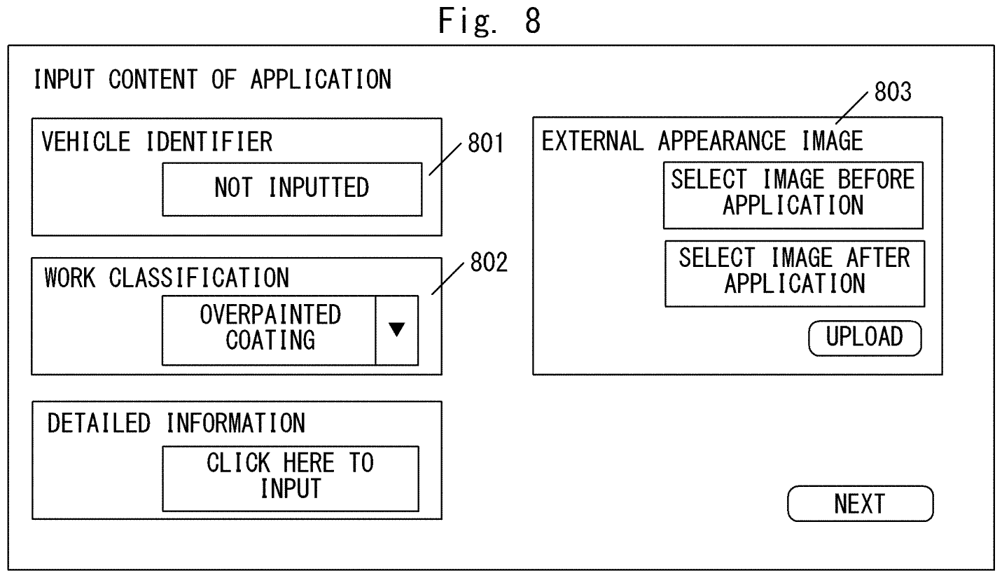

First, at step S11, information about the content of coating operation is acquired. At this step, for example, a vehicle identifier and a work classification are acquired. In this example, the work classification is any of “coating at the time of manufacturing a new automobile”, “overpainting (of coating)” and “peeling (of overpainted coating)”. The information may be inputted, for example, via a screen as illustrated in FIG. 8. In the example of FIG. 8, reference sign 801 indicates a GUI part for causing a vehicle identifier to be inputted. Reference sign 802 indicates a GUI part for causing a work classification to be selected.

At step S12, the work classification is judged. When the work classification is coating at the time of manufacturing a new automobile or overpainted coating, the process transitions to step S13.

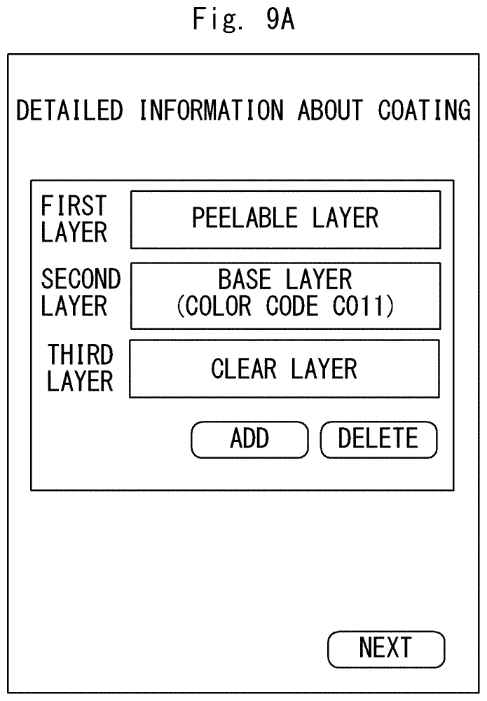

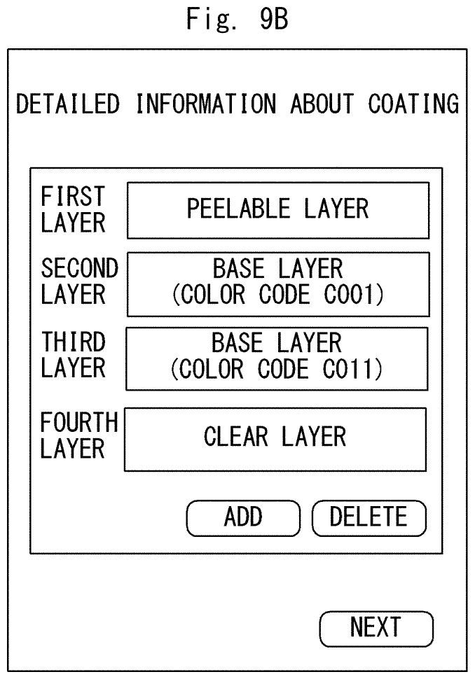

At step S13, detailed information about the coating is acquired. At this step, for example, the number of layers formed at the time of applying the coating, detailed information about paint corresponding to each layer and the like are acquired. These pieces of information may be inputted, for example, via screens as illustrated in FIGS. 9A and 9B. For example, FIG. 9A illustrates an input example in a case where after providing a transparent peelable layer, a base layer is provided, and then, a clear layer is provided. FIG. 9B illustrates an input example in a case where after providing a peelable layer, base layers respectively including different two kinds of colors are provided, and then, a clear layer is provided. Thus, it is also possible to input detailed information for each layer.

When the work classification is peeling of coating, the process transitions to step S14.

At step S14, information about peeling of the coating is acquired. At this step, for example, information to the effect that the top layer was removed by a predetermined means. The predetermined means is, for example, a means by a high-pressure water flow, manual operation or the like. The information about peeling of the coating may include the name of equipment used for peeling, a set value for a water pressure or the like.

At step S15, an external appearance image of the vehicle before the application and an external appearance image of the vehicle after the application are acquired. Reference sign 803 in FIG. 8 indicates a GUI part for selecting and uploading the external appearance images of the vehicle before and after the application. Note that the upload of the images may not be indispensable. Lastly, the controller 201 generates operation data that includes the information described above.

The operation data generated by the base server 200 is transmitted to the management server 100 and processed by the data update unit 1011.

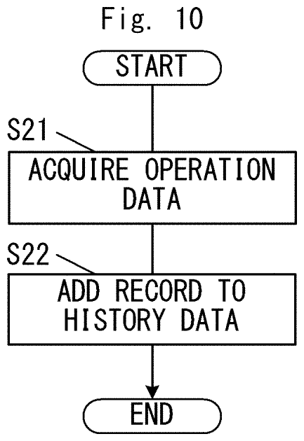

FIG. 10 is a flowchart of a database update process performed by the management server 100 (the data update unit 1011).

First, at step S21, operation data transmitted from the base server 200 is acquired.

Next, at step S22, a record corresponding to coating operation performed for a target vehicle is added to the coating database 102A. That is, a record that includes a vehicle identifier, an operation date, a vehicle base, a work classification, detailed information about coating, an image before application and an image after application is newly added. Note that, at the timing of database update being completed, the base server 200 may be notified thereof.

By the process described above, update of the coating database that the management server 100 includes is performed.

Next, a process for a user to search for a vehicle for sale will be described.

In response to a request transmitted from a user apparatus 300, the management server 100 provides detailed information about a vehicle under its management (the vehicle for sale).

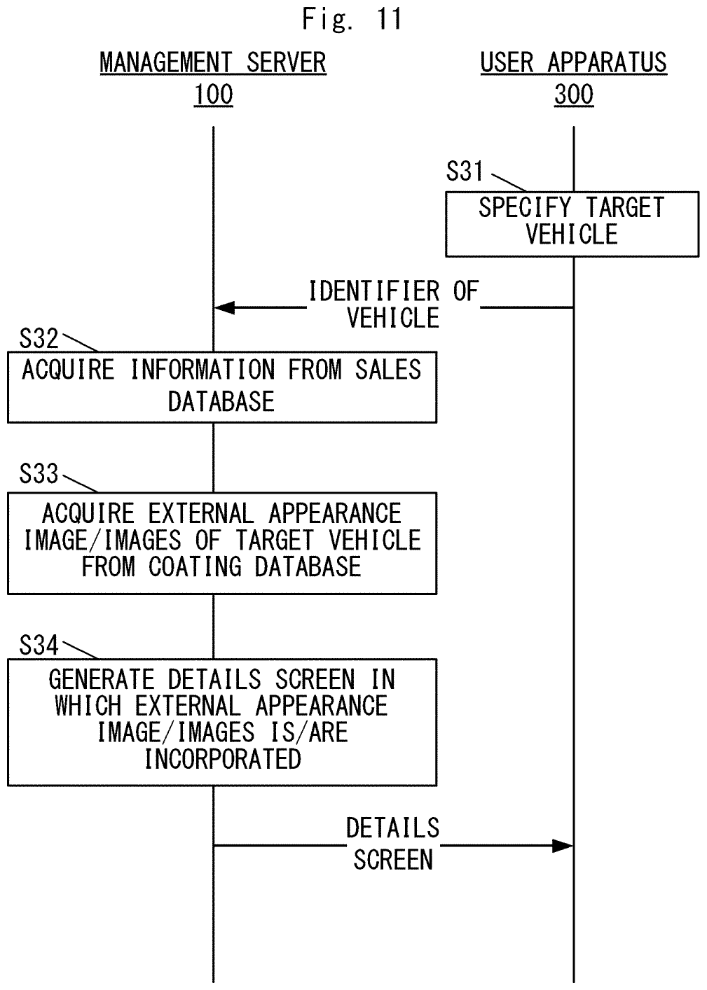

FIG. 11 is a sequence diagram of a process for the management server 100 to provide detailed information about a vehicle in response to a request from a user apparatus 300.

First, at step S31, the user apparatus 300 specifies a target vehicle. At this step, for example, the user performs vehicle inventory search and specifies a vehicle from an obtained list. The user apparatus 300 transmits an identifier for uniquely identifying the target vehicle to the management server 100.

Next, at step S32, the management server 100 acquires data corresponding to the specified vehicle from the sales database and temporarily stores the data.

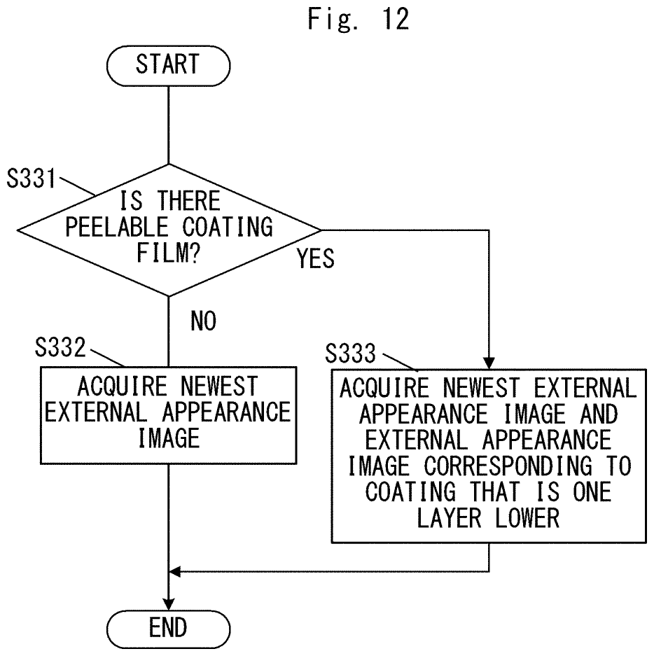

At step S33, the management server 100 acquires an external appearance image/external appearance images corresponding to the target vehicle. FIG. 12 is a flowchart illustrating details of the process at step S33.

First, at step S331, it is judged whether the target vehicle includes a peelable coating film or not. Whether the target vehicle includes a peelable coating film or not can be judged based on information stored in the coating database 102A.

When the target vehicle does not include a peelable coating film, the process transitions to step S332. When the target vehicle includes a peelable coating film, the process transitions to step S333.

At step S332, the newest external appearance image is acquired for the target vehicle.

At step S333, both of the newest external appearance image and an external appearance image before the peelable coating film being formed (that is, an external appearance image of a state in which coating one layer lower than the peelable coating film is exposed) are acquired for the target vehicle.

At step S34, the management server 100 generates a screen to be presented to the user, based on the data acquired at step S32 and the image data acquired at step S33.

For example, the management server 100 generates and outputs a screen that includes the detailed information about and the external appearance image/images of the vehicle. When the target vehicle includes a peelable coating film, the screen includes the following information.
Current coating state (whether a peelable coating film is applied or not)
Current body color (the color of a coating film that is currently exposed)
Current external appearance image
Original body color (the color of a coating film that appears when the current coating film is peeled)
Original external appearance image (an external appearance image when the current coating film is peeled)

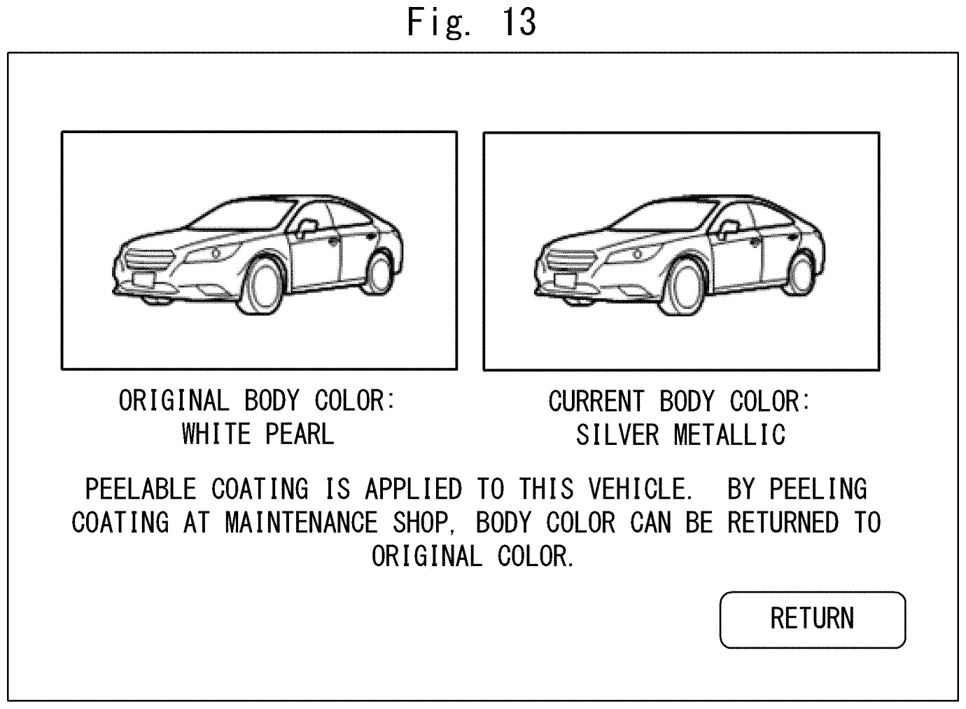

At this step, the management server 100 generates, for example, a screen to present detailed information about the color of the vehicle as illustrated in FIG. 13 in addition to general information about the vehicle as illustrated in FIG. 3. It is preferable that the screen is a screen in which the current and original external appearance images of the target vehicle can be compared.

The generated screen is transmitted to the user apparatus 300 and presented to the user.

As described above, in the vehicle management system according to the first embodiment, the management server 100 stores histories of coating operation for a plurality of vehicles under its management and stores information related to coating together with an external appearance image/external appearance images each time coating operation is performed.

Further, the management server 100 searches the sales database and provides detailed information about a vehicle together with an obtained external appearance image/external appearance images in response to the request. Thereby, it becomes possible to cause a user who purchases a vehicle to accurately grasp a state of coating of the target vehicle.

### Second Embodiment

In the first embodiment, an external appearance image/external appearance images of a vehicle is/are acquired and stored in a database each time coating operation is performed. In comparison, a second embodiment is an embodiment in which an external appearance image/external appearance images is/are not stored in a database, but an external appearance image/external appearance images corresponding to a target vehicle is/are generated by image processing. In this embodiment, an external appearance image of a vehicle is a CG image generated by the management server 100.

In the second embodiment, the coating database 102A does not store external appearance images of vehicles. Further, the base server 200 does not provide external appearance images of vehicles for the management server 100. Instead, the management server 100 generates an external appearance image of a vehicle with a predetermined color by performing image processing (color processing) on a sample image defined for each vehicle model.

In the second embodiment, at steps 5332 and S333, image processing is performed on a sample image based on information stored in the coating database 102A to generate an external appearance image, instead of acquiring an external appearance image. The sample image is a graphic illustrating an external appearance of a vehicle the body of which is not colored. The sample image may be such that is obtained by photographing an actual vehicle or may be such that is generated by computer graphics. The sample image is defined for each vehicle model.

For example, at step S332, the color of a coating film formed in coating operation performed last is acquired, and the sample image is colored by the acquired color.

Further, at step S333, a body color before a peelable coating film being formed (that is, a body color corresponding to the coating one layer lower than the peelable coating film) is acquired, and the sample image is colored by the acquired body color.

A process at and after step S34 is similar to that of the first embodiment.

According to the second embodiment, an external appearance image of a vehicle is generated by image processing based on color information stored in the coating database. Thereby, it becomes unnecessary to photograph an external appearance image of a vehicle each time coating operation is performed, and it is possible to reduce a load at the site.

Note that generation of an external appearance image by image processing may be performed in the first embodiment. For example, when any of an image before application and an image after application is missing for a certain vehicle, the missing image may be generated by image processing.

### Third Embodiment

When peelable coating is applied to a vehicle, the value of the vehicle may be higher than that of a vehicle to which overpainted coating is not applied, because lower-layer coating films are protected. A third embodiment is an embodiment in which, in consideration of such a case, the sales price of a vehicle is corrected according to a coating condition of the vehicle.

In the first and second embodiments, at step S34, a sales price recorded in the sales database is presented to a user as it is. On the other hand, in the third embodiment, when overpainted coating is applied to a target vehicle, the sales price is corrected according to the condition of the overpainted coating.

Note that, in the third embodiment, sales prices stored in the sales database are assumed to be prices that do not consider whether overpainted coating is applied or not.

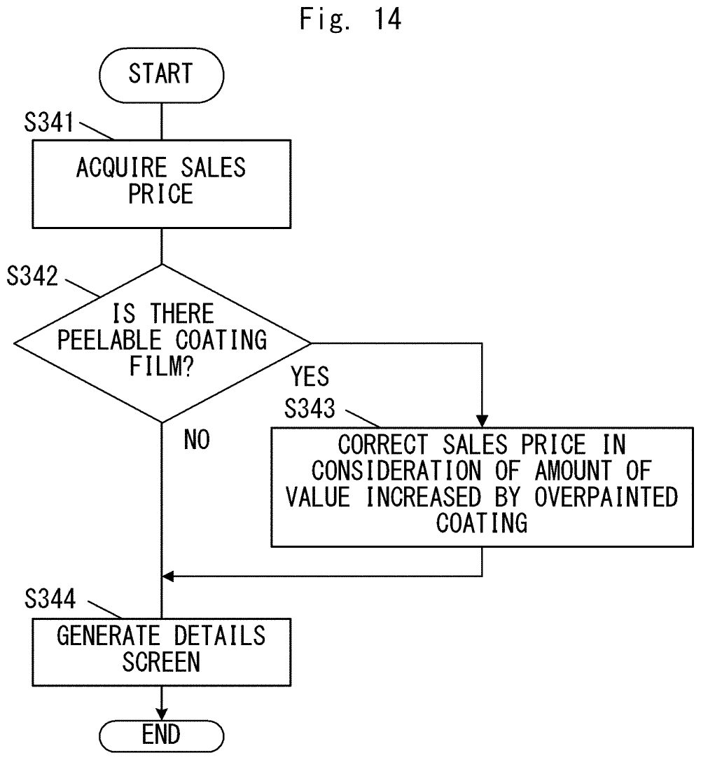

FIG. 14 is a flowchart illustrating details of a process executed at step S34 in the third embodiment.

First, at step S341, the sales price of a target vehicle recorded in the sales database is acquired.

Next, at step S342, it is judged whether the target vehicle includes a peelable coating film or not. Whether the target vehicle includes a peelable coating film or not can be judged based on information stored in the coating database 102A.

When the target vehicle does not include a peelable coating film, the process transitions to step S344. When the target vehicle includes a peelable coating film, the process transitions to step S343.

At step S343, after acquiring the sales price of the target vehicle recorded in the sales database, an amount of value increased by the overpainted coating is added to the sales price.

The amount of value increased by the overpainted coating may be calculated based on elapsed time after the overpainted coating being applied or the like, in addition to whether overpainted coating is applied or not. This is because, when the peelable coating film includes a useful life, it is thought that the value decreases as time elapses after application of the coating.

Correction of a sales price can be performed according to a predetermined rule based on the above factors. For example, the predetermined rule may be defined by a table or a formula and stored in the storage unit 102.

At step S344, a screen that includes the acquired or corrected sales price is generated.

According to the third embodiment, it becomes possible to calculate the value of a vehicle more accurately based on whether there is a peelable coating film or not.

Note that, though an example of adding an amount of value increased by overpainted coating to a sales price is given, correction of a sales price may be performed based on other factors. For example, when an original body color is a body color that is popular in the used automobile market, the value may be evaluated higher in comparison with a case where the original body color is not popular. Therefore, correction of a sales price may be performed further based on an original body color.

(Modifications)

The embodiments described above are mere examples, and the present disclosure can be appropriately changed and implemented within a range not departing from the spirit of the disclosure.

For example, the processes and means described in the present disclosure can be freely combined and implemented as far as technical inconsistency does not occur.

Further, a process described as being performed by one apparatus may be shared and executed by a plurality of apparatuses. Or alternatively, processes described as being performed by different apparatuses may be executed by one apparatus. In a computer system, by what hardware configuration (server configuration) each function is realized can be flexibly changed.

For example, the management server 100 may be separated in a first apparatus that acquires or generates external appearance images of vehicles and a second apparatus that provides information about vehicles for sale. In this case, the first apparatus functions as an apparatus that manages the coating database and provides an external appearance image of a specified vehicle. Further, the second apparatus functions as an apparatus that manages the sales database and generates a screen to be provided for a user in response to provision of the external appearance image.

The present disclosure can also be realized by supplying a computer program implemented with the functions described in the above embodiments to a computer, and one or more processors that the computer includes reading out and executing the program. Such a computer program may be provided for the computer by a non-transitory computer-readable storage medium that can be connected to the system bus of the computer or may be provided for the computer via a network. As the non-transitory computer-readable storage medium, for example, any type of disk such as a magnetic disk (a floppy (registered trademark) disk, a hard disk drive (HDD) or the like) and an optical disk (a CD-ROM, a DVD disk/a Blu-ray disc or the like), a read-only memory (ROM), a random access memory (RAM), an EPROM, an EEPROM, a magnetic card, a flash memory, an optical card and any type of medium suitable for storing electronic instructions are included.

What is claimed is:

1. An information processing apparatus comprising a controller comprising at least one processor, the controller being configured to execute:
acquiring, for a vehicle with a later peelable second coating film formed being layered on at least a part of a first coating film, history data that is data about work on the second coating film; and
acquiring a first image that is an external appearance image of the vehicle before the second coating film being formed, based on the history data.

2. The information processing apparatus according to claim 1, wherein the history data includes an external appearance image of the vehicle photographed before the second coating film being formed.

3. The information processing apparatus according to claim 1, wherein the history data includes color information that is information about a color of the first coating film.

4. The information processing apparatus according to claim 3, wherein the controller generates the first image by image processing based on the color information.

5. The information processing apparatus according to claim 1, wherein
the history data is data defined for each of identifiers of a plurality of vehicles, and
the controller acquires the corresponding first image based on a specified identifier.

6. The information processing apparatus according to claim 1, wherein the controller further acquires information about a profile of the vehicle and outputs the information together with the first image.

7. The information processing apparatus according to claim 1, wherein the controller further acquires a second image that is an external appearance image of the vehicle after the second coating film being formed, based on the history data.

8. The information processing apparatus according to claim 7, wherein the history data includes external appearance images of the vehicle photographed before and after the second coating film being formed.

9. The information processing apparatus according to claim 7, wherein the history data includes color information that is information about colors of the first coating film and the second coating film.

10. The information processing apparatus according to claim 9, wherein the controller generates the first image and the second image by image processing based on the color information.

11. The information processing apparatus according to claim 7, wherein the controller outputs the first image and the second image in such a format in which the images can be compared.

12. The information processing apparatus according to claim 7, wherein the controller further acquires information about a profile of the vehicle and outputs the information together with the first image and the second image.

13. The information processing apparatus according to claim 1, wherein the controller calculates each of a price of the vehicle in a case where the second coating film is peeled and a price of the vehicle in a case where the second coating film is not peeled.

14. An information processing method comprising providing information about a vehicle with a later peelable second coating film formed being layered on at least a part of a first coating film, wherein
a first image that is an external appearance image of the vehicle before the second coating film being formed is acquired based on history data that is data about work on the second coating film for the vehicle.

15. The information processing method according to claim 14, wherein the history data includes an external appearance image of the vehicle photographed before the second coating film being formed.

16. The information processing method according to claim 14, wherein the first image is generated by image processing based on color information that is information about a color of the first coating film.

17. The information processing method according to claim 14, wherein a second image that is an external appearance image of the vehicle after the second coating film being formed is further acquired based on the history data.

18. The information processing method according to claim 17, wherein the history data includes external appearance images of the vehicle photographed before and after the second coating film being formed.

19. The information processing method according to claim 17, wherein the first image and the second image are generated by image processing based on color information that is information about colors of the first coating film and the second coating film.

20. A non-transitory storage medium storing a program for causing a computer to execute the information processing method according to claim 14.
